(19) United States
(12) Patent Application Publication
(10) Pub. No.: US 2020/0358320 A1
(43) Pub. Date: Nov. 12, 2020

(54) Radio frequency charging network data optimization method based on reverse diffraction communication

(71) Applicant: Changlin Yang, Zhengzhou (CN)

(72) Inventor: Changlin Yang, Zhengzhou (CN)

(21) Appl. No.: 16/581,639

(22) Filed: Sep. 24, 2019

(30) Foreign Application Priority Data
May 6, 2019 (CN) 201910369942.X

(51) Int. Cl. H02J 50/27; H04W 52/14; H04W 52/38

(52) U.S. Cl. CPC H02J 50/27; H04W 52/383; H04W 52/14

(57) ABSTRACT

The invention disclosures a radio frequency charging network data optimization method based on reverse diffraction communication, comprising a node, the node comprises an antenna, the node collects radio frequency energy through radio frequency energy harvesting module and stores the energy in an energy storage module for the use by controller, data storage module, data acquisition module and other system modules, when the energy of a certain node is insufficient, passive transmission can be carried out with adjacent nodes, the invention provides a multifunctional node, the node can collect radio frequency energy, transmit data actively, reverse diffraction data and receive diffraction information from other nodes, when a node in the network is actively communicating, other nodes can conduct information exchange by reverse diffraction communication, especially nodes with lower energy. Thereby the data transmission amount of nodes with lower energy can be improved.

### BACKGROUND OF THE INVENTION

### 1. Field of the Invention

The invention relates to the technical field of reverse diffraction communication, in particular to a radio frequency charging network data optimization method based on reverse diffraction communication.

### 2. Background Art

In recent years, the radio frequency charging wireless sensor network has gradually become a new trend in the development of the Internet of Things with the advantage of remote charging. However, in the radio frequency charging wireless sensor network, there is still a big contradiction between the limited energy acquisition amount of nodes and the requirement of data transmission. For example, when the WIFI is used as the node of transmission media, 90% of energy is consumed in the transmission data. The mainly application of reverse diffraction communication is Radio Frequency Identification Device (RFID). In this system, the radio frequency transmitter (also known as reader) sends a normal waveform to the radio frequency node, the radio frequency node reflects or absorbs the waveform through a built-in circuit.

‘1’ is transmitted when reflected, and ‘0’ is transmitted when absorbed. The reader can obtain the information transmitted by the radio frequency node according to the reflected waveform. Simultaneously, since the radio frequency node only reflects the incidence radio frequency, the node does not need to consume energy, and the typical applications include: bus card, entrance guard card and commodity information, etc. Therefore, a method of using reverse diffraction communication is proposed to reduce the energy consumed by data transmission, thereby increasing the data transmission amount.

### SUMMARY OF THE INVENTION

In order to solve above problem, the invention provides a radio frequency charging network data optimization method based on reverse diffraction communication, comprising a node, the node comprises an antenna, the antenna is connected to four modules of radio frequency energy harvesting module, reverse diffraction demodulation module, reverse diffraction modulation module, and radio frequency transmitting module, the node collects radio frequency energy through the radio frequency energy harvesting module and stores the energy in an energy storage module for the use by controller, data storage module, data acquisition module and other system modules, the energy in the energy storage module provides node communication by the radio frequency transmitting module when the energy in the energy storage module is sufficient, and when the energy in the energy storage module is insufficient, active transmission can be carried out in other similar modules and reverse diffraction communication can be used for transmission.

Further, when the energy of a certain node is insufficient, passive transmission can be carried out with adjacent nodes, and when determining which nodes can be transmitted by reverse diffraction, assuming that ζ is threshold value of node reverse diffraction, the node can conduct reverse diffraction when incidence radio frequency energy is above the threshold value; assuming that p is active radio frequency transmission power, g is channel loss between two nodes, that is, when node k conducts an active transmission, incident energy of node i needs to satisfy the following formula to conduct reverse diffraction communication: pgₖᵢ≥ζ.

Further, when node k conducts an active transmission, all nodes which can conduct reverse diffraction communication and target nodes thereof can be obtained, assuming that r is communication distance of reverse diffraction, d is straight line distance between two nodes, thereby all reverse diffraction communication link (l,j) and a set thereof Bₖ is: Bₖ={(l,j)|pgₖₗ≥ζ, dₗⱼ≤r,∀l,j∈I}, in the formula, I refers to all nodes, l and j refer to initial node and target node respectively, each transmission group can be obtained according to the set B of the link, that is, the link which can simultaneously conduct reverse diffraction, which is in order to avoid data collision: when a node is receiving reverse diffraction communication, there can be at most one transmitter within the range r of the node, and G^{k}ₕ is used to indicate the hth transmission group when the node k conducts active communication.

By adopting above technical schemes, the invention has the following beneficial effects:

The invention provides a multifunctional node, the node can collect radio frequency energy, transmit data actively, reverse diffraction data and receive diffraction information from other nodes, when a node in the network is actively communicating, other nodes can conduct information exchange by reverse diffraction communication, especially nodes with lower energy. Thereby the data transmission amount of nodes with lower energy can be improved.

### DETAILED DESCRIPTION OF THE DRAWINGS

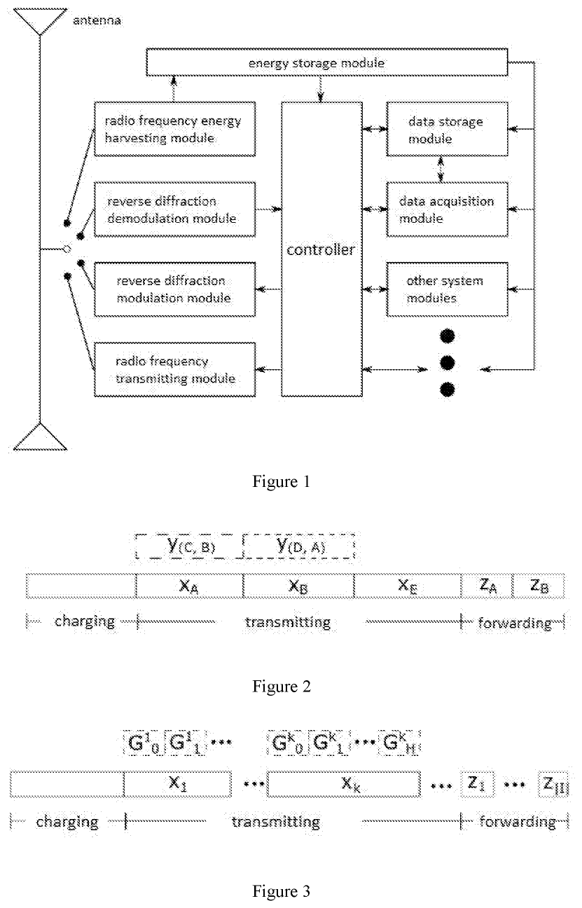

FIG. 1 shows the nodes of the invention;

FIG. 2 shows radio frequency charging network and scheduling process based on reverse diffraction communication of the invention;

FIG. 3 shows optimized network scheduling of the invention;

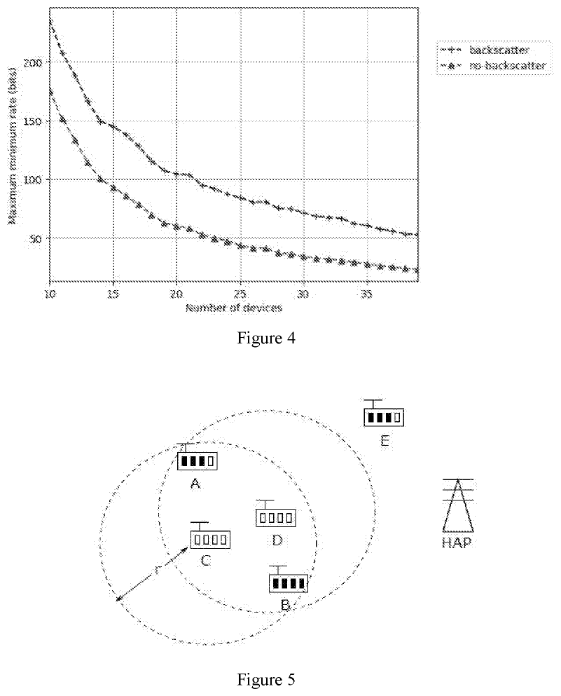

FIG. 4 is a comparison diagram of simulation experiments of the maximum and minimum data transmission rates of a network using reverse diffraction communication and no reverse diffraction communication according to the invention;

FIG. 5 shows a model of reverse diffraction communication of the invention.

### THE PREFERRED EMBODIMENTS OF THE INVENTION

Embodiment 1: As shown in FIG. 1-5, a radio frequency charging network data optimization method based on reverse diffraction communication, as shown in FIG. 1, comprising a node, the node comprises an antenna, the antenna is connected to four modules of radio frequency energy harvesting module, reverse diffraction demodulation module, reverse diffraction modulation module, and radio frequency transmitting module, the node collects radio frequency energy through the radio frequency energy harvesting module and stores the energy in an energy storage module for the use by controller, data storage module, data acquisition module and other system modules, the energy in the energy storage module provides node communication by the radio frequency transmitting module when the energy in the energy storage module is sufficient, and when the energy in the energy storage module is insufficient, active transmission can be carried out in other similar modules and reverse diffraction communication can be used for transmission.

As shown in FIG. 5, dividing a charging and transmission process into three periods, first charging, then transmitting and finally forwarding, assuming that nodes C and D acquire no energy, and the energy of nodes A, B, and E are labeled as black squares, at this point, C can transmit data to B by reverse diffraction communication when the node A transmits data to data center, and vice versa, node D can transmit data to A by reverse diffraction communication when B transmits data to the data center, finally, in the period of forwarding, the nodes A and B may receive data from C and D and transmit the data to data center, thereby data amount of C and D can be improved. Noted that the maximum and minimum data for the network is 0 when reverse diffraction communication is not considered. This is because C and D do not have enough energy to conduct active radio frequency communication.

When the energy of a certain node is insufficient, passive transmission can be carried out with adjacent nodes, and when determining which nodes can be transmitted by reverse diffraction, assuming that ζ is threshold value of node reverse diffraction, the node can conduct reverse diffraction when incidence radio frequency energy is above the threshold value; assuming that p is active radio frequency transmission power, g is channel loss between two nodes, that is, when node k conducts an active transmission, incident energy of node i needs to satisfy the following formula to conduct reverse diffraction communication: pgₖᵢ≥ζ.

When node k conducts an active transmission, all nodes which can conduct reverse diffraction communication and target nodes thereof can be obtained, assuming that r is communication distance of reverse diffraction, d is straight line distance between two nodes, thereby all reverse diffraction communication link (l,j) and a set thereof Bₖ is: Bₖ={(l,j)|pgₖₗ≥ζ, dₗⱼ≤r,∀l,j∈I}, in the formula, I refers to all nodes, l and j refer to initial node and target node respectively, each transmission group can be obtained according to the set B of the link, that is, the link which can simultaneously conduct reverse diffraction, which is in order to avoid data collision: when a node is receiving reverse diffraction communication, there can be at most one transmitter within the range r of the node, and G^{k}ₕ is used to indicate the hth transmission group when the node k conducts active communication.

The data is optimized according to the linear programming method, the objective equation is maximized minimum data transmission amount, and the programming constraints are: 1. energy restriction; 2. data conservation constraint. Optimization variable are: x, active transmission time of the node; yₕ^{k}, activation time of transmission group h at node k during transmitting; z, length of time of node forwarding. After optimization, the data transmission is as shown in FIG. 3, each node is activated in turn, simultaneously, the reverse diffraction transmission group that needs to be activated is also activated in turn, and finally the reversely diffracted data is forwarded.

When node k conducts an active transmission, all nodes which can conduct reverse diffraction communication and target nodes thereof can be obtained, assuming that r is communication distance of reverse diffraction, d is straight line distance between two nodes, thereby all reverse diffraction communication link (l,j) and a set thereof Bₖ is: Bₖ={(l,j)|pgₖₗ≥ζ, dₗⱼ≤r,∀l,j∈I}, in the formula, I refers to all nodes, l and j refer to initial node and target node respectively, each transmission group can be obtained according to the set B of the link, the link which can simultaneously conduct reverse diffraction, which is in order to avoid data collision: when a node is receiving reverse diffraction communication, there can be at most one transmitter within the range r of the node, and G^{k}ₕ is used to indicate the hth transmission group when the node k conducts active communication.

As shown in FIG. 4, the maximum and minimum data transmission rates of the network of using reverse diffraction communication (backscatter) and no-using reverse diffraction communication (no-backscatter) are compared, when the number of nodes is increased, the rate can be doubled by using reverse diffraction communication (when there are 39 nodes, 52 bits for using reverse diffraction communication and 23 bits for no-using reverse diffraction communication), and when the number of nodes is small, such as 10 nodes, the data transmission amount can be improved by 30% by reverse diffraction communication.

The invention provides a multifunctional node, the node can collect radio frequency energy, transmit data actively, reverse diffraction data and receive diffraction information from other nodes, when a node in the network is actively communicating, other nodes can conduct information exchange by reverse diffraction communication, especially nodes with lower energy. Thereby the data transmission amount of nodes with lower energy can be improved.

The basic principles and main features of the invention are described above, and it should be understood by those skilled in the art that the invention is not limited by the foregoing embodiments while the above embodiments and specifications describe only the principles of the invention, various modifications and improvements of the invention can be made without departing from the scope of the invention, which are within the scope of the invention as claimed. The scope of the invention is defined by the appended claims and their equivalents.

1. A radio frequency charging network data optimization method based on reverse diffraction communication, comprising a node, the node comprises an antenna, the antenna is connected to four modules of radio frequency energy harvesting module, reverse diffraction demodulation module, reverse diffraction modulation module, and radio frequency transmitting module, the node collects radio frequency energy through the radio frequency energy harvesting module and stores the energy in an energy storage module for the use by controller, data storage module, data acquisition module and other system modules, the energy in the energy storage module provides node communication by the radio frequency transmitting module when the energy in the energy storage module is sufficient, and when the energy in the energy storage module is insufficient, active transmission can be carried out in other similar modules and reverse diffraction communication can be used for transmission.

2. The radio frequency charging network data optimization method based on reverse diffraction communication of claim 1, wherein when the energy of a certain node is insufficient, passive transmission can be carried out with adjacent nodes, and when determining which nodes can be transmitted by reverse diffraction, assuming that ζ is threshold value of node reverse diffraction, the node can conduct reverse diffraction when incidence radio frequency energy is above the threshold value; assuming that p is active radio frequency transmission power, g is channel loss between two nodes, that is, when node k conducts an active transmission, incident energy of node i needs to satisfy the following formula to conduct reverse diffraction communication: pgₖᵢ≥ζ.

3. The radio frequency charging network data optimization method based on reverse diffraction communication of claim 1, wherein when node k conducts an active transmission, all nodes which can conduct reverse diffraction communication and target nodes thereof can be obtained, assuming that r is communication distance of reverse diffraction, d is straight line distance between two nodes, thereby all reverse diffraction communication link (l,j) and a set thereof Bₖ is: Bₖ={(l,j)|pgₖₗ≥ζ, dₗⱼ≤r,∀l,j∈I}, in the formula, I refers to all nodes, l and j refer to initial node and target node respectively, each transmission group can be obtained according to the set B of the link, that is, the link which can simultaneously conduct reverse diffraction, which is in order to avoid data collision: when a node is receiving reverse diffraction communication, there can be at most one transmitter within the range r of the node, and G^{k}ₕ is used to indicate the hth transmission group when the node k conducts active communication.
